(19) United States
(12) Patent Application Publication
(10) Pub. No.: US 2008/0034114 A1
(43) Pub. Date: Feb. 7, 2008

(54) System and method for managing emergency notifications over network

(75) Inventors: Richard V. Ducey, Bethesda, MD (US); Edward G. Czarnecki, Reston, VA (US); Mark O'Brien, Great Falls, VA (US)

Correspondence Address: BUCHANAN, INGERSOLL & ROONEY PC, POST OFFICE BOX 1404, ALEXANDRIA, VA, 22313-1404, US

(73) Assignee: SpectraRep, Chantilly, VA (US)

(21) Appl. No.: 11/826,192

(22) Filed: Jul. 12, 2007

Related U.S. Application Data
(60) Provisional application No. 60/830,100, filed on Jul. 12, 2006.

(51) Int. Cl. G06F 15/173; H04L 9/00

(52) U.S. Cl. 709/238; 713/180

(57) ABSTRACT

Systems and methods are disclosed for managing event and emergency notification over a network. A message is generated in a first interface according to an emergency data sharing standard, the message having a length, duration, or size determined by each one of a plurality of data formats for transmission. The message is addressed to the second interfaces allocated with predetermined recipients. The message is transmitted to each second interface in the data format supported by each second interface. The transmitted message is received in at least one of the second interfaces, and outputted in the data format supported by the at least one second interface.

### FIELD

A method and system for managing event and emergency notification over a network are disclosed.

### BACKGROUND

The Emergency Alert System (EAS) is designed to provide the President with a means to address the American people in the event of a national emergency. Beginning in 1963, the President permitted state and local emergency information to be transmitted by the system. Since then, local emergency management personnel have used the EAS to relay local emergency messages via broadcast stations, cable, and wireless cable systems. In October 2005, the Federal Communications Commission expanded the EAS rules to require EAS participation by digital television broadcasters (DTV), digital cable providers, digital broadcast radio, satellite radio services (Digital Audio Radio Service) and satellite television (Direct Broadcast Satellite) systems. These rules took effect on Dec. 31, 2006, except for the DBS rules, which took effect on May 31, 2007. While participation in national EAS is mandatory for these providers, state, and local EAS participation currently is voluntary.

In the EAS system, emergency messages include a header that provides information about the message originator, the type of event, the area affected, the duration of the alert, the time the alert was issued, and the station identification. This header is transmitted in three bursts with each message to ensure message integrity.

A decoder at the receiving station interprets the message and generates three sounding tones based on the three-header burst. The decoder then decides whether to ignore the message or relay it on the air. The decoder will ignore the message if the message does not pertain to the local area associated with that particular decoder.

The header bursts are followed by a frequency shift key (FSK) alert tone, which lasts between 8 and 25 seconds depending on the originating station, the number of affected areas and/or other factors. The alert tone carries no information and is a combination of 853 Hz and 960 Hz sine wave tones. This combination of tones is the same as was used in the emergency broadcast system that preceded the Emergency Alert System. The tone is then followed by a voice message giving details of the alert.

The EAS system relies on the “daisy chaining” technique of relaying messages among a number of devices between the message originator and message recipient such that if one of the intervening devices is not operational the message transmission may fail to reach all intended recipients. Also, the EAS system does not provide complete information relative to an emergency, and useful information relative to responding to the emergency. The EAS system allows emergency messages to reach broadcasters. The system does not provide a secure transmission of messages, or support the transmission of digital audio, extended duration audio (more than two minutes for other than national level EAS messages) video, multimedia, data files or any file attachment with a message.

### SUMMARY

An exemplary method is directed to managing event and emergency notification over a network. The method comprises generating a message in a first interface according to an emergency data sharing standard, the message having a length, duration, or size determined by selected data formats. The method also comprises addressing the message to a second interface associated with a predetermined recipient, and transmitting the message to each second interface in one of the selected data formats supported by each second interface. The transmitted message is received in at least one of the second interfaces, and outputted in the data format supported by the at least one second interface.

Another exemplary method is directed to generating emergency alerts on a network. The method comprises generating a first interface having data fields for creating a message, and activating selected data fields based on a user input to create the message in a plurality of data formats. The message is compiled into a data format supported by an emergency data sharing standard language, the message having a length, duration, or size determined by the data format into which the message is compiled. The method also includes sending the compiled message to the second interfaces on the network via a gateway device.

An exemplary method is directed to managing event and emergency notification over a digital communication medium. The method comprises receiving an alert message, generating an audible and visual alarm based on the received message, and processing the alert message to extract event information and message format data. The event information is displayed in a graphical interface based on the message format, wherein the alert message is displayed as at least one of a web feed, an email, and a text message and with associated data.

An exemplary computer readable medium is directed to storing a computer program for executing a method for generating an alert message. The method comprising generating an interface having data fields for creating a message, and activating selected data fields based on a user input to create the message in a plurality of data formats. The data associated with the activated data fields is compiled into the data formats supported by an emergency data sharing standard language, the message having a length, duration, and size determined by the data format into which the message is compiled. The method also comprises sending the compiled message to the at least one second interface via a gateway device.

Another exemplary computer readable medium is directed to storing a computer program for executing a method for managing event and emergency notification. The method comprises receiving an alert message, generating an audible and visual alarm based on the received alert message, and processing the alert message to extract event information and message format data. The event information is displayed in a graphical interface based on the message format data, wherein the alert message is displayed as at least one of a web feed, an email, and a text message and with associated data.

An exemplary system for opting in is directed to exchanging event and emergency notification messages on a network. The system comprises first communication means for generating an alert message, the first communication means having interface means for graphically displaying data fields used to create the alert message in a plurality of data formats, wherein the data fields are modified through a user input; first processing means for compiling the alert message; and transmitting means for sending the compiled message to a gateway device on the network. The system also comprises second communication means for providing the alert message to a user, the second communication means having receiver means for receiving the alert message over the network; second processing means for extracting event information and for detecting a supported message format; and display means for displaying the event information in a graphical interface based on the message format, wherein the event information is displayed as at least one of a web feed, an email, and a message.

### DRAWINGS

In the following, exemplary embodiments of the alert management system will be described in greater detail with reference to the drawings, wherein:

FIG. 1 illustrates administrator-client system components in accordance with an exemplary embodiment of an alert management system;

FIG. 2 illustrates an overview of the alert management system;

FIG. 3 illustrates a satellite network architecture in accordance with an exemplary embodiment of the alert management system;

FIG. 4 illustrates an exemplary digital television (DTV) datacast network architecture in accordance with an embodiment of the alert management system;

FIG. 5 is a flowchart illustrating an exemplary method of generating an alert message in accordance with an embodiment of the alert management system;

FIG. 6 is a flowchart illustrating an exemplary method of processing an alert message of a recipient in accordance with an embodiment of the alert management system;

FIG. 7 is a flowchart illustrating an exemplary method of processing an alert message received by a recipient in accordance with an embodiment of the alert management system;

FIG. 8 illustrates an exemplary satellite, datacast, and Internet combined network architecture in accordance with an embodiment of the alert management system;

FIG. 9 illustrates an exemplary combined network architecture with portable message origination in accordance with an embodiment of the alert management system;

FIG. 10 illustrates an exemplary DTV datacast digital signage network architecture in accordance with an embodiment of the alert management system; and

FIG. 11 illustrates an exemplary combined satellite and DTV datacast digital signage network architecture in accordance with an embodiment of the alert management system.

### DETAILED DESCRIPTION

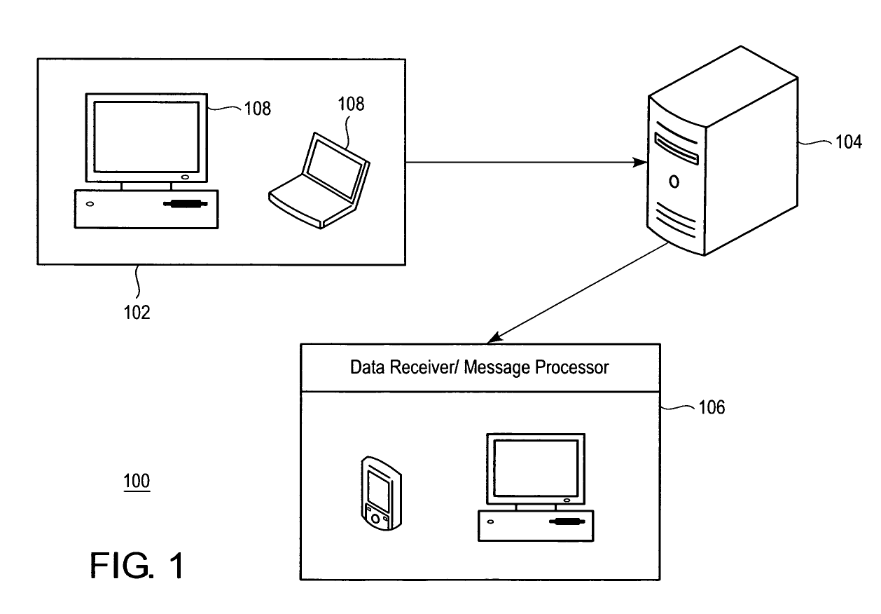

FIG. 1 illustrates an exemplary alert management system (AMS) 100 for managing event and emergency notification over a network. The AMS 100 can enable national, state, and local governments, school authorities, campuses, businesses and other organizations to distribute emergency alert messages, which may include amber alerts, severe weather information, national security alerts, environmental emergencies, public safety alerts, bulletins, and other urgent information to the public over a network that can use the Internet as the backbone. The AMS can be configured to distribute information regarding emergency events to government sites, agencies, and/or other state or local enterprises that are directly involved in managing or responding to the event.

The alert message content can be generated in an Internet Protocol (IP) based language according to the Common Alerting Protocol (CAP) standard. The alert message may be transmitted in the IP protocol format as a text message or email message or processed further for transmission in a variety of other formats including datacast, satellite, cable, or any other media format driven by the device requirements of a recipient.

The AMS 100 provides for attachment of files to a message, the automatic posting of alert information to web sites, and the automatic triggering of tone alert radio devices, sirens, in-building alarms, strobe lights, mobile phones, and other devices used to visually or audibly notify persons of an emergency event. The AMS 100 provides for secure message transmission by verifying verifies whether authorized administrators are generating alert messages and authorized recipients are receiving the alert messages.

The file attachments that can be used as a news and information service providing both live and store-and-forward multimedia content and other data to broadcasters, government, enterprises, campuses, and other sites.

As shown in FIG. 1, the AMS 100 includes means such as a command center 102 for generating alert messages and emergency notification through a web-based graphical user interface and means, such as a server core 104, for compiling the data input through the interface into an extensible markup language or any other suitable programming language based on the CAP. The AMS 100 also includes means, such as a processor 106, for receiving, processing, displaying, and managing incoming messages.

The command center 102 can be configured to include a command console 108. The command console 108 can include a software application for generating and managing targeted alert messages through an interface. Each alert message is generated through the software interface based on data input by an administrator and can be targeted to various combinations of recipients, as desired. Through a combination of the alert management software and circuitry, the command console 108 provides the capability to manage the content of an alert message to suit the requirements of each targeted recipient. In particular, the command console 108 can encode, encrypt, attach metadata tags, or apply various other formatting techniques to the message to ensure that a targeted recipient may properly receive and access the alert message. Moreover, the messages can be generated at various lengths, durations, or sizes to include content suitable to alert a recipient of an emergency event. The limit on the length, duration, or size of the generated message is determined by the processing capabilities of the targeted recipient. The command console 108 may also generate the FSK alert tones that are generated under the current EAS system.

The server core 104 is a PC or other computing device (i.e., a gateway device) that compiles the data input through the interface into an extensible markup language (XML) based on the CAP standard. The server 104 receives the alert message from the command console 108 and formats the message for transmission to the targeted recipients as a series of IP packets. The server can format the alert message for transmission using, for example, DTV datacast, satellite, a wireless transmission standard (WiFi), digital radio, Worldwide Interoperability for Microwave Access (WiMax), or Internet providers. In addition, the server 104 can format the alert message for targeted recipients over handheld devices using a wireless communication protocol such as Short Message Service (SMS), Multimedia Message Service (MMS), Enhanced Message Services (EMS), or any other suitable protocol as desired.

The processor 106 is associated with a recipient and can include any communication device that is compatible with the existing EAS. The processor 106 can include data cards or can be connected to a data receiver for reception of emergency information via satellite, DTV data broadcast, WiMax, digital radio, and the Internet. These devices include radio, television, or cable-receivers. The processor 106 can also be implemented through a personal computer, cellular communication device, or any other device that is capable of receiving and processing IP packets over a network.

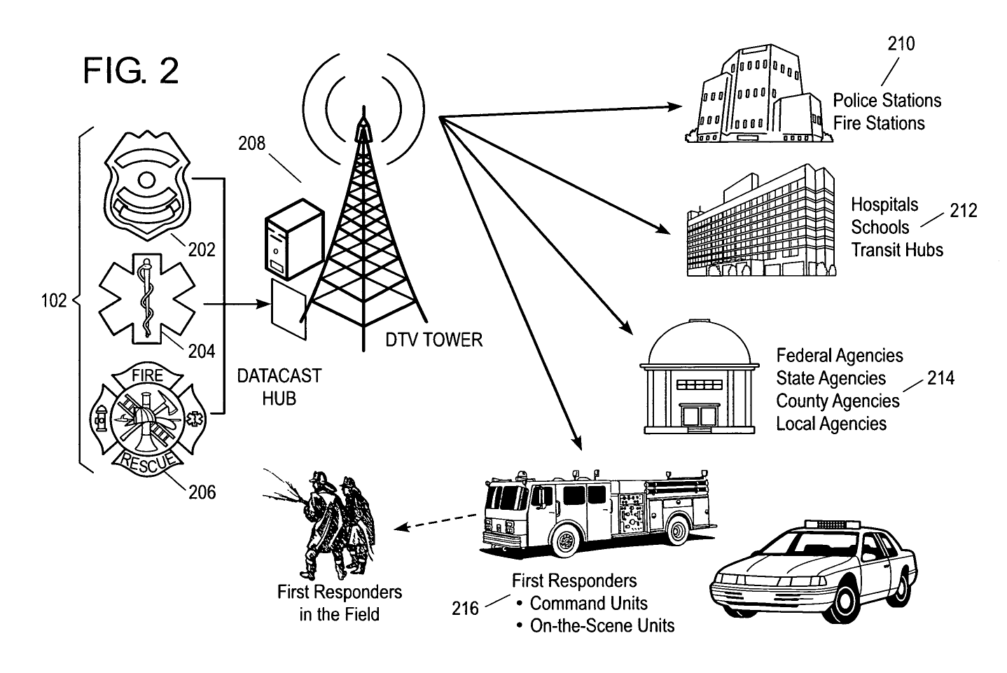

FIG. 2 illustrates an exemplary implementation of the AMS 100. As shown in FIG. 2, any one or combination of law enforcement agencies 202, emergency medical services 204, and fire and rescue departments 206 can generate alert messages and emergency notifications as a command center 102. The generated messages can be sent to a server 208 for formatting based on a particular network protocol or architecture. The server 208 can transmit the formatted messages to recipients in the selected format. Any combination of police and fire stations 210, hospitals, schools, or transit hubs 212, government agencies 214, and first responders 216 can serve as targeted recipients that receive the messages through a computing means, such as the processor 106, for processing, displaying, and managing incoming messages.

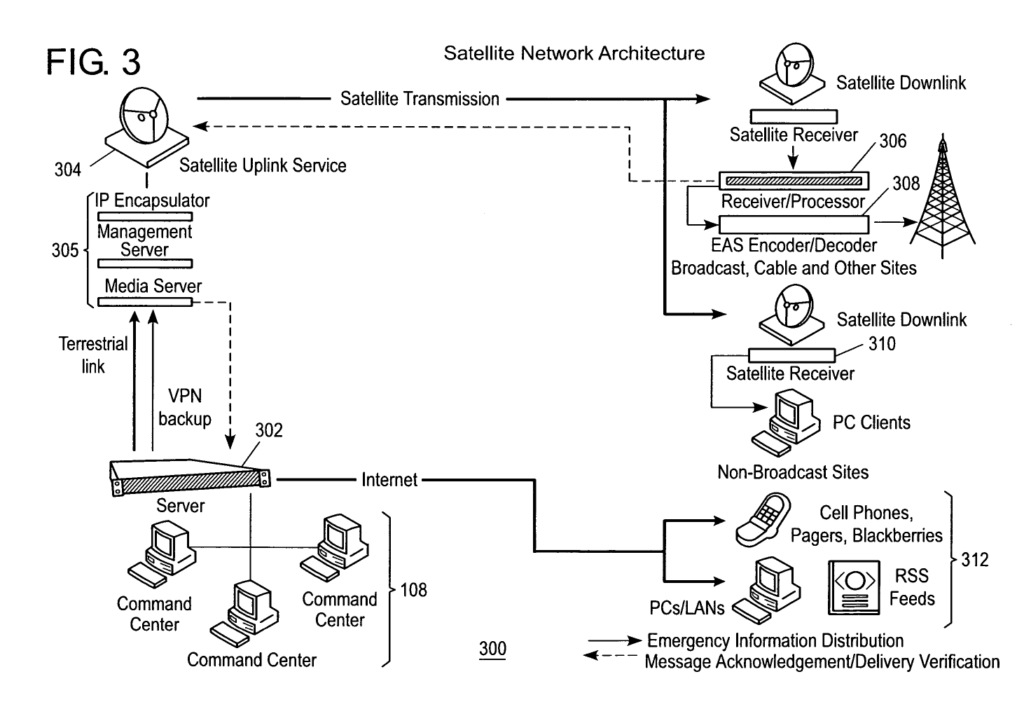

FIG. 3 illustrates an exemplary AMS 300 configured according to satellite network architecture. As shown in FIG. 3, the server 302 receives an alert message from the command console 108 and formats the message for transmission to the targeted recipients over a satellite or Internet communication medium. In formatting the alert message, the server 302 injects the IP packets of the message content including an encryption, forward error connection or other message related processes into a satellite data signal.

The server 302 can then uplink the data stream to a communications satellite 304 via a satellite network server 305. The server 302 can uplink the data through any one or a combination of known transmission techniques such as a terrestrial link, virtual private network (VPN), or other suitable connection as desired.

The satellite network server 305 can include any combination of processing means, such as an IP encapsulator, server devices, or other suitable computing devices, for formatting the data stream for uplink to the communications satellite 304. The communication satellite 304 downlinks the satellite data signal to a receiver 306 coupled to a decoder 308 so that the message can be distributed to the targeted recipients 308 through additional relays via the Internet, a DTV datacast broadcast, a satellite network, a WiFi network, or a WiMax network, or any other suitable transmission protocol as desired. The communication satellite 304 can also downlink the data stream directly to a computing device of a recipient via a satellite receiver 310.

To distribute the alert message over Internet, the server 302 can further process the message through known techniques so that targeted recipients may receive and view the alert message as a web feed, or an email. In addition, the recipient may also access attached multimedia files through associated software applications.

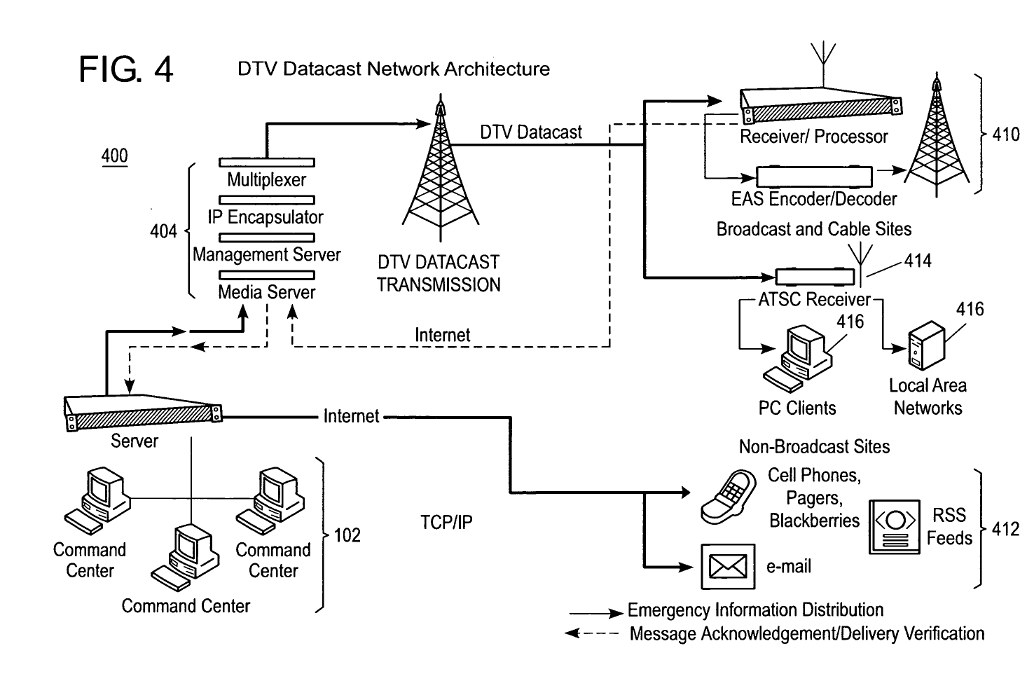

FIG. 4 illustrates an exemplary AMS 400 configured according to a DTV datacast network architecture. As shown in FIG. 4, a server 402 receives an alert message from the command center 102 and formats the message for transmission to a datacast server 404. In formatting an alert message for broadcast as a datacast signal, the datacast server 404 injects the IP packets of the message content including any encryption, forward error correction or other message related processes into a digital television broadcast transport stream, for example. The datacast server 404 can be configured to include a combination of devices such as a multiplexer 406, IP encapsulator 408, and other suitable processing devices as desired. The datacast server 404 sends the digital broadcast stream to a datacast-enabled broadcaster 410. The datacast-enabled broadcaster 410 transmits the alert message through television signals to targeted recipients. The datacast server 404 can also transmit the alert message to targeted recipients 412 having a datacast receiver 414 coupled to a computing device 416, such as a PC or network server. The server 402 can further process the message through known techniques so that targeted recipients may receive and view the alert message as a web feed, or an email. In addition, the recipient may also access attached multimedia files through associated software applications.

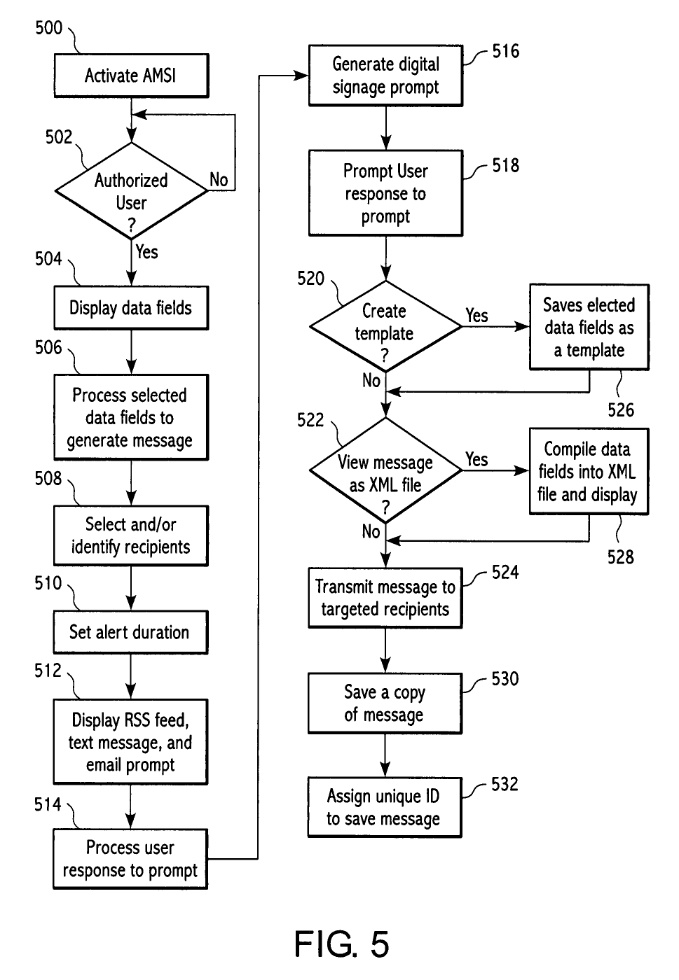

FIG. 5 is a flowchart illustrating an exemplary method of managing an alert message or emergency notification over a network in accordance with the AMS 100. An administrator at the command console activates an alert management software interface (AMSI) to generate an alert message. The AMSI is a user friendly interface that organizes and structures various data fields and processes which may rely on business rules, stored procedures, error checking, security or other procedures and methods so that an administrator may quickly and efficiently generate an alert message according to the Common Alerting Protocol (CAP) standard.

When the AMSI interface is activated (step 500), an administrator is prompted to enter a user name and password so that authorized access to the EAS network can be verified (Step 502). Once authorization to the system is granted, the AMSI displays a plurality of data fields customized for that particular user (Step 504). Each data field is associated with a different aspect of the alert message and provides information to a recipient based on the CAP standard. These data fields may include but are not limited to a message type, a message scope, the type of event, a location of the event, the event category, an urgency code for the event, a severity of the event, a certainty of an event, a recommended response action, information regarding the originator of the message, audience, detailed description and detailed instructions. The data fields can include user selection interfaces such as radio buttons for text entry so that the administrator may select among a number of possible data entries. The data fields can also include an area for text entry that enables the administrator to enter a specific description related to the event.

Once the emergency is described through the selection or manipulation of the data fields the AMSI processes these selections (step 506). The AMSI prompts the administrator to identify those recipients to whom the alert message is targeted (Step 508). The targeted recipients can be identified through the selection of an existing distribution list. The distribution list enables users to be selected as a group or on an individual basis. Recipients can be addressed through email accounts, text messaging accounts, or similar addressed associated with other TCP/IP communication formats. Additional distribution lists can be created or modified as required.

The AMSI further prompts the administrator to indicate the duration of an alert in either specific (e.g., “the message expires at 11:00 PM”) or relative (“the message expires in 1 hour”) time and indicate whether the message is a test, draft, an exercise, or an actual alert notification (Step 510). In addition to broadcast recipients, the AMSI prompts the administrator to indicate whether the message is to be transmitted as a broadcast EAS Really Simple Syndication (RSS) feed and/or a text or email message (Step 512). In this same step, the AMSI also prompts the administrator to attach voice, video, data, RSS, email, text, MMS, EMS, Instant Messaging (IM) or other multimedia files to the alert message. The AMSI processes the administrator's input in response to the prompts (Step 514).

As a security feature, the AMSI can prompt the administrator to digitally sign the message (Step 516). If the administrator selects the signature prompt, at transmission the AMSI encrypts the alert message using any of the known public-key cryptology methods (Step 518).

When the administrator has responded to each AMSI prompt for data entry, the AMSI provides a summary of the selected data fields and data entries prior to transmitting the message to recipients. At the same time, the AMSI displays a summary of what is about to be transmitted, allowing the administrator to go back and edit any the selection of data fields and data entries, create a message template (step 520), view an extensible markup language (XML) version of the message (step 522), and transmit the alert message (step 524).

Prior to transmission, the administrator has the option to return to any previous screen and modify any parameters.

If the administrator desires to create a template, the AMSI saves the selected data fields and data entries as a message template so that the administrator may quickly generate the same or similar messages for future emergencies or events (Step 526).

If the administrator desires to view an XML prompt, the AMSI compiles the selected data fields and data entries into an XML data file and displays this program to the administrator (Step 528).

If the administrator desires to transmits the alert message, the AMSI compiles the message based on the entered data and transmits the message to the server using an emergency data sharing standard, the message having a length, duration, and size determined by the data transmission format (Step 524). In addition, the AMSI saves a copy of the transmitted message in a message log (Step 530). The AMSI assigns a unique ID to each message in the message log and may display the messages based on any of the data fields selected by the administrator when the logged message was generated (Step 532), for example, the type of message, the message scope, and the date created. The message log enables the administrator to review, copy, edit, reuse, and delete any previously generated message. The message log is archived and this archive cannot be deleted as a matter of default policy so that a record is preserved. Previously issued alerts can also be cancelled or updated and then retransmitted.

At a recipient location, a PC or a similarly capable device must activate a recipient alert management software interface (RAMSI) to receive and display an alert message. When active and an alert message targeted to the recipient PC is received, the RAMSI enables standard and user configurable options including the ability to generate an audible alert and displays a scrolling banner or a window. When prompted by a user input, the RAMSI displays a list of received alert messages. When selected by a user, the RAMSI displays a description of the alert message and indicates whether any attachments are provided with the selected alert message. The RAMSI also displays a message description window, where if selected by the user, the RAMSI displays the data fields and data entries selected by the administrator in describing the emergency and the recommended response according to the CAP standard. The RAMSI stores each received message in a message log. The RAMSI may display the messages stored in the message log according to the message content, the date and time received, or the message status.

If the message is received at the recipient location via messaging (e.g., SMS, MMS, IM, EMS) or email, the notification process that is germane to the application on the device will control.

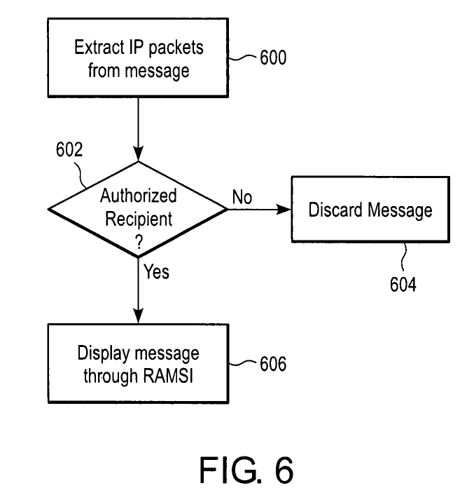

FIG. 6 is a flowchart illustrating an exemplary method of processing an alert message of a recipient in the AMS 100.

To receive an alert message in a datacast, satellite, WiFi or WiMax communications format, the data card or data receiver of the personal computer is tuned to the appropriate channel or frequency for receiving that type of signal (Step 600). When a signal including alert message is received the data card or data receiver extracts the IP packets from the signal (Step 602). The data card or receiver then processes the IP packets to determine whether the recipient is authorized to receive the alert message (Step 604). If the alert message is not addressed to the recipient, the data card or data receiver aborts processing the packets and the alert message is discarded (Step 606). If the alert message is addressed to the recipient, the IP packets are forwarded to the processor of the personal computer so that the alert message may be displayed through the alert management interface (Step 608). The details of accessing a message through the interface are discussed in greater detail below.

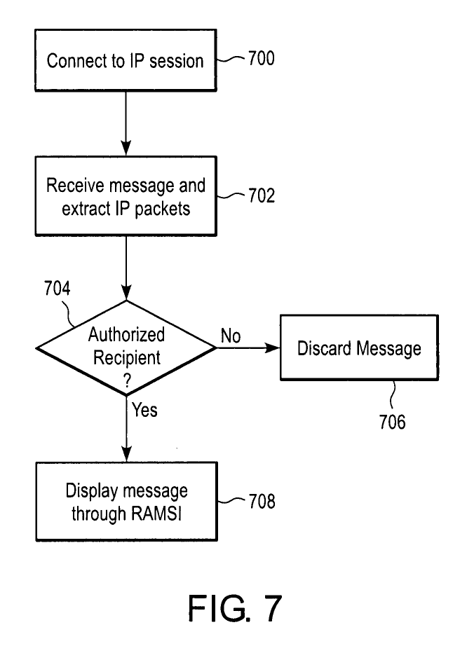

FIG. 7 is a flowchart illustrating an exemplary method processing an alert message received on the Internet. To receive an alert message via Internet the computing device or personal computer connects to either a transmission control protocol (TCP) or user datagram protocol (UDP) session for receiving that type of signal (Step 700). When a signal including alert message is received by the computing device the client software extracts the IP packets from the signal (Step 702). The client then processes the IP packets to determine whether the recipient is authorized to receive the alert message (Step 704). If the alert message is not addressed to the recipient, the client aborts processing the packets and the alert message is discarded (Step 706). If the alert message is addressed to the recipient, the IP packets are forwarded to the processor of the personal computer so that the alert message may be displayed through the alert management interface (Step 708). The details of accessing a message through the interface are discussed in greater detail below.

If the recipient receives the alert message through a cellular communications device such as a cell phone with text messaging capabilities or a pager, for example, the recipient will be notified of the received message and may view the received alert message any other text message or page is received.

If the recipient receives, through permission-based (e.g., an opt-in selection) or other method, the alert message through a desktop application with messaging capabilities, email or subscribe and publish services such as Really Simple Syndication (RSS) feeds, the recipient will be notified of the received message and may view the received alert message, associated data or files or any other text message that is received.

One of ordinary skill would appreciate that the AMS can be configured to distribute alert messages and emergency notifications over a combined network architecture.

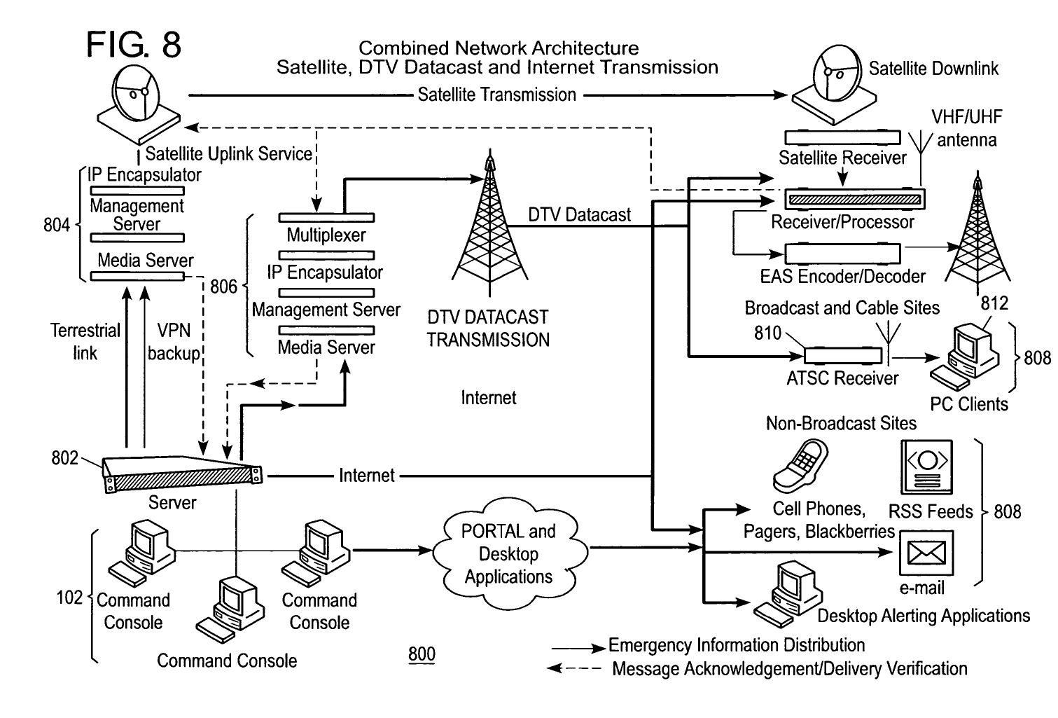

FIG. 8 illustrates an exemplary AMS 800 configured to distribute alert messages and emergency notifications through a combined satellite, DTV datacast, and Internet TCP/IP architecture. As shown in FIG. 8, a server 802 receives the message from the command console 102. The server 802 formats the message for transmission to gateway devices such as a satellite network server 804, a datacast network server 806, and over the Internet. Each server 804, 806 formats the message content for transmission over the respective satellite and datacast networks, respectively. The recipients 808 receive the message through a receiver 810 that is connected to a processor or computing device 812. The receiver 810 is configured to extract the message content based on the associated protocol. The processor 812 is configured to receive the extracted message content from the receiver and display the message content through a graphical interface or other suitable display means. The server 802 can further process the message through known techniques so that targeted recipients 808 may receive and view the alert message as a web feed, or an email. In addition, the recipient may also access attached multimedia files through associated software applications. Moreover, each device at the command console 102 can be configured to communicate with targeted recipients 808 through a VPN or other suitable network.

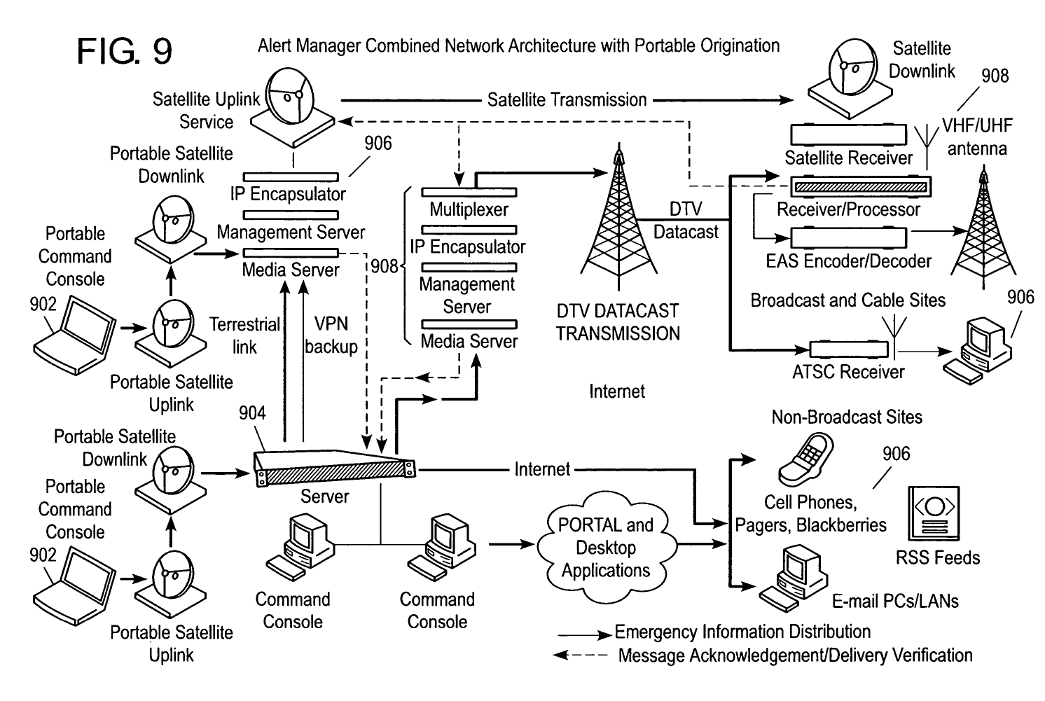

FIG. 9 illustrates an exemplary AMS 900 configured to distribute an alert message over a combined network architecture, wherein the alert message originates from a portable computing device 902. As shown in FIG. 9, the portable computing device 902 can generate an alert message or emergency notification and transmit the message to a server 904 through a satellite uplink/downlink architecture. The server 904 formats the received message for transmission to a satellite network server 906, a datacast network server 908, and over the Internet. Each server 906, 908 includes means, such as an IP encapsulator, a multiplexer, and other processing devices as desired, for formatting the message for broadcast over their respective networks to targeted recipients 906. The server 904 can further process the message through known techniques so that targeted recipients 906 may receive and view the alert message as a web feed, or an email. In addition, the recipient may also access attached multimedia files through associated software applications. Moreover, each device at the command console 102 can be configured to communicate with targeted recipients 906 through a VPN or other suitable network.

One of ordinary skill would appreciate that because the portable computing device 902 is connected to communicate over a satellite link, the portable computing device 902 can be configured to bypass the server 904 and transmit generated messages directly to the satellite network server 906 for distribution to the targeted recipients 906.

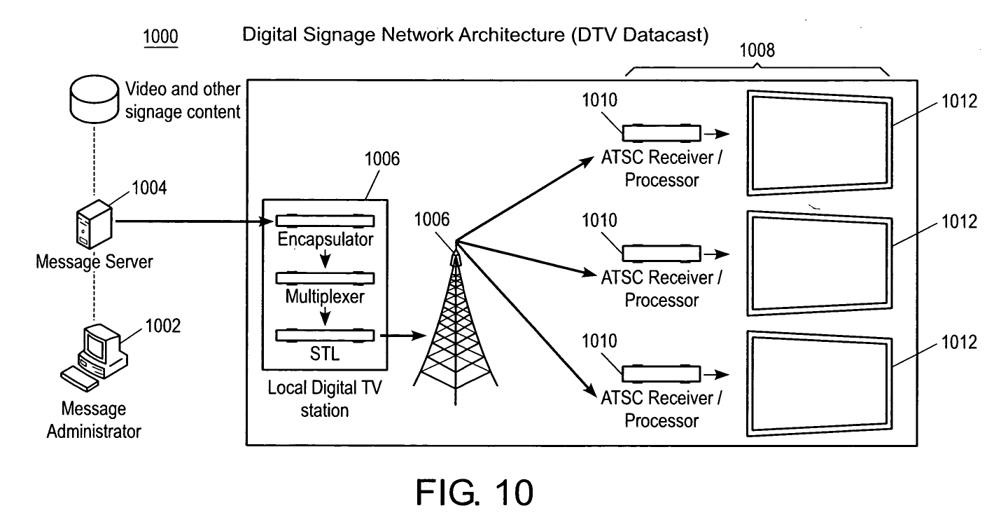

FIG. 10 illustrates an exemplary alert management system 1000 having a digital signage feature over a DTV datacast network architecture. As shown in FIG. 10, a message is generated by an administrator at a command console 1002. The command console 1002 sends the message to a server 1004, which formats the message for transmission over a broadband network. Because the message was generated at the command console 1002 with a digital signature, the server 1004 attaches files, such as video, audio, and other signage content associated with the digital signature. The server 1004 transmits the message along with the attached files to a datacast broadcaster 1006. The datacast broadcaster 1006 formats the message and attachments for distribution to targeted recipients 1008. The datacast broadcaster 1006 can include various computing devices such as an encapsulator, multiplexer, and other devices as needed to properly distribute the message. Each targeted recipient receives the message through a receiver 1010 that is capable of processing the message in accordance with the Advanced Television Systems Communication (ATSC) standard. The receiver 1010 extracts the message content and sends the extracted data to a display 1012.

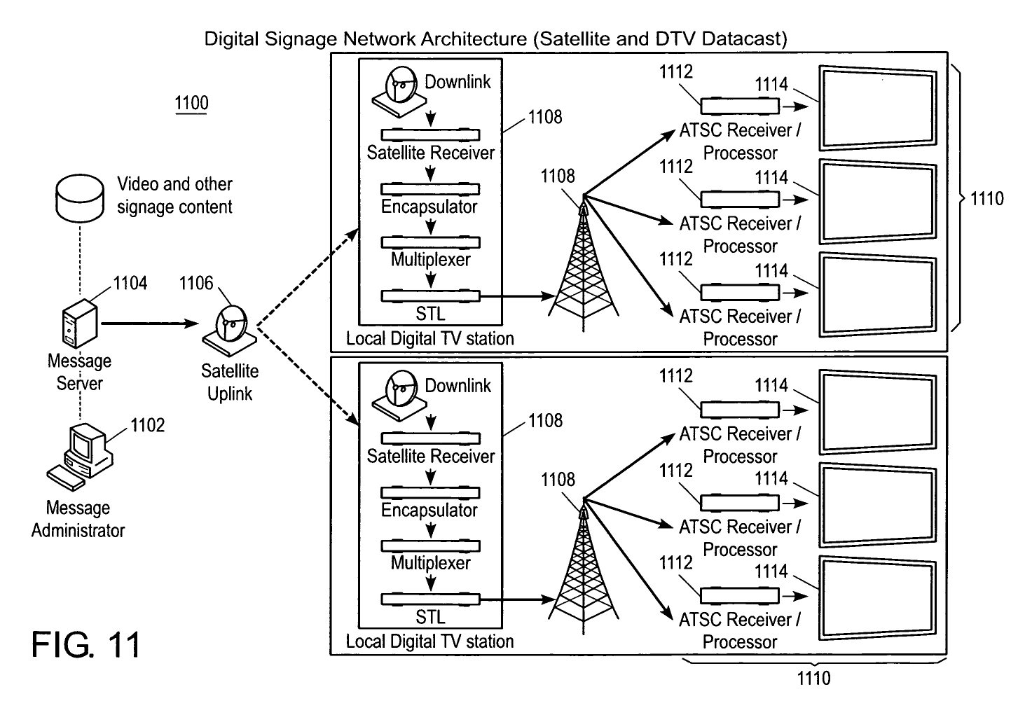

FIG. 11 illustrates an exemplary combined satellite and DTV datacast digital signage network architecture in accordance with an embodiment of the alert management system. As shown in FIG. 11, a message is generated by an administrator at a command console 1102. The command console 1102 sends the message to a server 1104, which formats the message for transmission over a broadband network. Because the message was generated at the command console 1102 with a digital signature, the server 1104 attaches files, such as video, audio, and other signage content associated with the digital signature. The server 1104 uplinks the message and attached files to a communications satellite 1106. The message and attached files are then downlinked from the communications satellite 1106 to a DTV datacast broadcaster 1 108. The datacast broadcaster 1108 formats the message and attachments for distribution to targeted recipients 1110. The datacast broadcaster 1008 can include various computing devices such as a satellite receiver, encapsulator, multiplexer, and other devices as needed to properly distribute the message. Each targeted recipient receives the message through a receiver 1112 that is capable of processing the message in accordance with the Advanced Television Systems Communication (ATSC) standard. The receiver 1112 extracts the message content and sends the extracted data to a display 1114.

Beyond emergency notification, the alert management system may be used as a platform to provide e.g., public information briefings and video casts, distance learning applications through streaming video via digital television, pre-incident training through post-incident recovery and cleanup to first responders and emergency managers, and provide various other services relating to incident management including emergency/disaster training and planning resources, storm tracking, hazardous material (HAZMAT) databases, operating procedures and checklists, hazmat locations and handling protocols, and contingency plans. Through the alert management system and network, user communities such as police/fire/EMS, schools, ports, transportation, National Guard, business groups, emergency management, and critical infrastructure may be provided with reliable and real-time information through a user-friendly interface.

The functionality of the invention with respect to the command console, the server, and the processor of the recipient is implemented through software. Such software can be provided as a computer program product comprising computer program code which, when run on a computer or other suitable computing device, causes the computer to perform the functionality according to the invention. Such a computer program code can be stored on a computer readable medium, such as suitable memory means, e.g. a flash memory or a disc memory, from which it is loadable to the processor or computing device executing the program code. In addition, such a computer program code implementing the invention can be loaded to the processor or computing device executing the computer program code via a suitable data network, for example, and it can replace or update a possibly existing program code.

While the invention has been described with reference to specific embodiments, this description is merely representative of the invention and is not to be construed as limiting the invention. Various modifications and applications may occur to those skilled in the art without departing from the true spirit and scope of the invention as defined by the appended claims.

What we claim is:

1. A method for managing event and emergency notification over a network, the method comprising:
generating a message in a first interface according to an emergency data sharing standard, the message having a length, duration, or size determined each one of a plurality of data formats for transmission;
addressing the message to a second interface associated with a predetermined recipient;
transmitting the message to each second interface in one of the selected data formats supported by each second interface;
receiving the transmitted message in at least one of the second interfaces; and
outputting the received message in the data format supported by the at least one second interface.

2. The method of claim 1, comprising:
encrypting the generated message.

3. The method of claim 1, comprising:
attaching a digital signature to the generated message.

4. The method of claim 1, comprising:
receiving, at the first interface, an acknowledgment that the message was transmitted successfully.

5. The method of claim 1, comprising:
storing the generated message in a message log.

6. The method of claim 5, comprising:
classifying each stored message based on at least one of a message status, a message type, a message author, a message date, a message ID.

7. The method of claim 1, comprising:
assigning a unique identifier to each generated message.

8. The method of claim 1, comprising:
creating a template based on the generated message.

9. The method of claim 1, comprising:
restricting access to the first and second interfaces to authorized users.

10. The method of claim 1, comprising:
encoding the generated message with frequency shift-key tones for backwards compatibility with a legacy emergency alert system.

11. The method of claim 1, comprising:
selecting a first message of each generated message; and
assigning a time at which each first message expires.

12. The method of claim 1, wherein the generating of the message comprises:
optionally attaching at least one of a video, audio, and data file to the message.

13. The method of claim 1, wherein the addressing of the message comprises:
creating and modifying distribution lists and select predetermined recipients from a distribution list.

14. The method of claim 1, wherein the message is transmitted in an Internet protocol data format as at least one of a web feed, an email, and a message and associated data.

15. The method of claim 1, wherein the message is generated based on certain business rules supported in the application.

16. The method claim 1, wherein the supported data format includes at least one of a datacast data format, a satellite communications data format, an Internet protocol data format, and a mobile communications data format.

17. A method for generating emergency alerts on a network, the method comprising:
generating a first interface having data fields for creating a message;
activating selected data fields based on a user input to create the message in a plurality of data formats for transmission;
compiling the message into the data formats supported by an emergency data sharing standard language, the message having a length, duration, or size determined by the data format into which it is compiled; and
sending the compiled message to the second interfaces on the network via a gateway device.

18. The method of claim 17, comprising:
restricting access to the generated interface to authorized users.

19. The method of claim 17, comprising:
encoding the compiled messages with frequency shift key tones.

20. The method of claim 17, comprising:
storing the compiled message in an archive.

21. The method of claim 17, comprising:
attaching a digital signature to the generated message.

22. The method of claim 17, comprising:
receiving, at the first interface, an acknowledgment that the message was transmitted successfully.

23. The method of claim 17, wherein the sending of the compiled data comprises:
sending the message as at least one of a web feed, an email, and a message and associated data.

24. A method for managing event and emergency notification over a digital communication medium, the method comprising:
receiving an alert message;
generating an audible and visual alarm based on the received alert message;
processing the alert message to extract event information and message format data; and
displaying the event information in a graphical interface based on the message format data, wherein the alert message is displayed as at least one of a web feed, an email, and a message, and with associated data.

25. The method of claim 24, wherein the alert message is an email message, instant message, or mobile message.

26. The method of claim 24, comprising:
storing the received alert message in a message log.

27. The method of claim 26, comprising:
classifying each stored message based on at least one of a message status, a message type, a message author, a message date, and a message ID.

28. The method of claim 24, comprising:
identifying at least one data file attached to the alert message;
activating a software application for executing the at least one data file; and
displaying the data file in the graphical interface through the software application.

29. The method of claim 24, wherein the activated software application includes at least one of a word processor, a streaming audio and video player, and a live video player.

30. A computer readable medium that stores a computer program for executing a method for generating an alert message, the method comprising:
generating an interface having data fields for creating a message in a plurality of data formats;
activating selected data fields based on a user input;
compiling data associated with the activated data fields based on an emergency data sharing standard language; and
sending the compiled message to a gateway device on the network.

31. A computer readable medium that stores a computer program for executing a method for managing event and emergency notification, the method comprising:
receiving an alert message;
generating an audible and visual alarm based on the received alert message;
processing the alert message to extract event information and message format data; and
displaying the event information in a graphical interface based on the message format data, wherein the alert message is displayed as at least one of a web feed, an email, and a message, and with associated data.

32. A system for exchanging event and emergency notification messages on a network, the system comprising:
first communication means for generating an alert message, the first communication means having interface means for graphically displaying data fields used to create the alert message in at least one of a plurality of data formats for transmission, wherein the data fields are modified through a user input;
first processing means for compiling the alert message;
transmitting means for sending the compiled message to a gateway device on the network;
second communication means for providing the alert message to a user, the second communication means having receiver means for receiving the alert message over the network;
second processing means for extracting event information and for detecting a supported message format; and
display means for displaying the event information in a graphical interface based on the message format, wherein the event information is displayed as at least one of a web feed, an email, and a message.

33. The system of claim 32, wherein the first processing means encodes the alert message with frequency shift key tones.

34. The system of claim 32, wherein the first processing means stores the compiled alert message in a message log.

35. The system of claim 32, wherein the first processing means compiles the alert message in at least one of a datacast data format, a satellite communications data format, and an Internet protocol data format.

36. The system of claim 32, wherein the transmitting means transmits the alert message as at least one of a web feed, an email, and a message and with associated data.

37. The system of claim 32, wherein the second processing means identifies at least one data file attached to the alert message and activates a software application for executing the at least one data file.

38. The system of claim 37, wherein the display means displays the at least one data file in the graphical interface through the software application.
